(19) United States
(12) Patent Application Publication
(10) Pub. No.: US 2020/0276592 A1
(43) Pub. Date: Sep. 3, 2020

(54) PRESSURE PLATE APPARATUS

(71) Applicant: McCloskey International Limited, Keene (CA)

(72) Inventors: Dennis Duellman, Cudahy, WI (US); Marian Ando, Cudahy, WI (US); Andrzej Krol, Keene (CA)

(73) Assignee: McCloskey International Limited, Keene (CA)

(21) Appl. No.: 16/288,403

(22) Filed: Feb. 28, 2019

(51) Int. Cl. B02C 2/04; B02C 1/10; B02C 13/18

(52) U.S. Cl. CPC B02C 2/047; B02C 25/00; B02C 13/1807; B02C 1/10

(57) ABSTRACT

A system for maintaining a downward force on a central shaft of a cone crusher having a stationary frame, including a disc fixedly mounted to the frame, the disc having a centrally-disposed aperture with a first diameter. A plate is mounted to an end cap, the plate having a second diameter that is greater than the first diameter. The plate is disposed distally of the disc and the end cap is disposed proximally of the disc. A housing is fixed to the central shaft and biased away from the end cap wherein a downward bias is imparted to the central shaft.

### TECHNICAL FIELD

Embodiments disclosed herein relate generally to cone crushers and more specifically to a system for preventing the tendency of a cone crusher head to elevated and/or to rotate.

### BACKGROUND

Cone crushers are typically used to crush large rocks into smaller rocks at quarries. They include a conical crushing head that gyrates with a central shaft, the gyration of which is caused by a rotating eccentric surrounding the shaft. A hardened mantle covers the crushing head to crush rocks between it and a hardened liner of the crusher bowl in a crushing zone. The eccentric is driven by a diesel engine or electric motor power drive.

A cone head ball surface is typically mounted to the central shaft. This ball surface carries downward thrust loads, which it passes on to a stationary socket and thrust bearings disposed below the ball surface and socket interface. The thrust forces push the ball surface down on the stationary socket, creating friction that normally holds the shaft from rotating with the rotation of the eccentric. The downward thrust forces are anything but constant as the mantle gyrates and rocks enter and exit the crushing chamber. Without constant and substantial friction between the ball, which is mounted to the central shaft, and the stationary socket, the shaft and the mantle mounted to it may tend to rotate, which may create problems with the operation of the crusher.

Another drawback with some existing cone crushers is that, under particularly cold conditions, some cone crushers will exhibit what is called “cone head lift.” This phenomenon sometimes occurs during warm up of the crusher in cold weather, when the lubricating oil is especially viscous. Under these conditions, high internal fluid pressure may exceed the weight of the shaft and head, causing the head to lift. This can result in oil leakage and oil contamination, as well as damage to the oil seals. This cone head lift can be addressed by keeping a relatively constant downward pressure on the shaft, preventing the lifting even when forces generated by the thickened oil exceed the weight of the shaft and head.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a side elevation sectional view of a cone crusher incorporating the disclosed embodiment of the pressure plate apparatus;

FIG. 2 is an enlarged, fragmentary side elevation view of the pressure plate apparatus embodiment shown in FIG. 1;

FIG. 3 is a perspective view of the top side of the embodiment of the pressure plate of FIGS. 1 and 2;

FIG. 4 is a perspective view of the bottom side of the embodiment of the pressure plate of FIGS. 1 and 2;

FIG. 5 is a top plan view of the pressure plate of FIGS. 3 and 4;

FIG. 6 is a side elevation view of the pressure plate of the prior figures;

FIG. 7 is a bottom view of the pressure plate of the prior figures;

FIG. 8 is a side elevation sectional view taken along line 8-8 of FIG. 5;

FIG. 9 is a perspective view of the bottom of a thrust disc washer of the embodiment of FIGS. 1 and 2;

FIG. 10 is a bottom view of the thrust disc washer of FIG. 9;

FIG. 11 is a side elevation sectional view of the thrust disc washer taken along line 11-11 of FIG. 10;

FIG. 12 is a perspective view from the top of an end cap of the embodiment of FIGS. 1 and 2;

FIG. 13 is a top plan view of the embodiment of the end cap of FIG. 12;

FIG. 14 is a side elevation view of the end cap of FIGS. 13 and 14;

FIG. 15 is a front elevation view of the end cap of FIGS. 13 and 14, taken from a vantage point offset by 90 degrees from that of FIG. 14;

FIG. 16 is a bottom view of the end cap of FIGS. 13 and 14;

FIG. 17 is a perspective view of the housing of the embodiment of FIGS. 1 and 2, taken from a bottom angle;

FIG. 18 is a perspective view of the housing of the embodiment of FIGS. 1 and 2, taken from an upper angle;

FIG. 19 is a bottom view of the housing of the embodiment of FIGS. 1 and 2;

FIG. 20 is a side elevation view of the housing of the embodiment of FIGS. 1 and 2; and

FIG. 21 is a sectional view of a portion of the pressure plate apparatus taken from an upper perspective.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact.

However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

The disclosed embodiment provides a continuous downward force on the crusher shaft, thus ensuring that there will be adequate friction between the previously-described ball and socket. This ensures that the head of the crusher will not rotate with the eccentric.

Embodiments include a system for maintaining a downward force on a central shaft of a cone crusher having a stationary frame, including a disc fixedly mounted to the frame, the disc having a centrally-disposed aperture with a first diameter. A plate is mounted to an end cap, the plate having a second diameter that is greater than the first diameter. The plate is disposed distally of the disc and the end cap is disposed proximally of the disc. A housing is fixed to the central shaft and biased away from the end cap wherein a downward bias is imparted to the central shaft.

The housing may be slidably mounted to the end cap and/or the plate. The plate may be threadably mounted to the end cap. The bias may be generated by at least one spring disposed between the housing and the end cap. Gyration may be imparted to the central shaft by an eccentric, and the gyration of the central shaft may be passed to the plate, which gyrates with respect to the disc.

The plate may be indirectly mounted to the central shaft such that any gyration of the central shaft is passed on to the plate, which gyrates with respect to the disc and is in contact with an underside of the disc at least part of the time.

The disclosed embodiments also include a pressure plate apparatus for mounting to a central shaft that gyrates in a cone crusher, the pressure plate maintaining a downward force on the central shaft during crushing operations. The apparatus may include a housing fixed to an underside of the central shaft, the housing slidably receiving an end cap and a raised portion of a plate. At least one spring may be mounted between the end cap and the housing to bias the plate toward the central shaft. A disc may be fixed to a stationary frame of the crusher, the disc having an aperture with a first diameter and being disposed between the plate and the housing, the plate having a second diameter that is greater than the first diameter. The plate may gyrate with the central shaft on the disc for some of the crushing operations and, in other crushing operations, the at least one spring may push the plate away from the disc to maintain a downward force on the central shaft.

Other embodiments may include a process for maintaining downward pressure on the cone of a cone crusher having a stationary frame, a central shaft, a first and a second thrust bearing surface mounted to the central shaft that absorb at least some downward thrust during crushing operations, and a rotating eccentric that gyrates the central shaft with respect to the frame. The process includes the following steps, not necessarily in the order recited: positioning at least one spring adjacent a housing; mounting an end cap to the housing such that the at least one spring is disposed between the housing and the end cap; fixing the housing to the central shaft and in doing so, compressing the at least one spring; fixing a disc to a lower portion of the frame, the disc having a centrally-disposed aperture having a first diameter; selecting a plate having a second diameter that is greater than the first diameter; and mounting the plate to the end cap such that the disc is disposed between the plate and the end cap so that when crushing operations are initiated, the plate will gyrate with the central shaft and with respect to the disc. The process may also include the step of maintaining spring tension on the central shaft, thus maintaining pressure between the first and second thrust bearing surfaces.

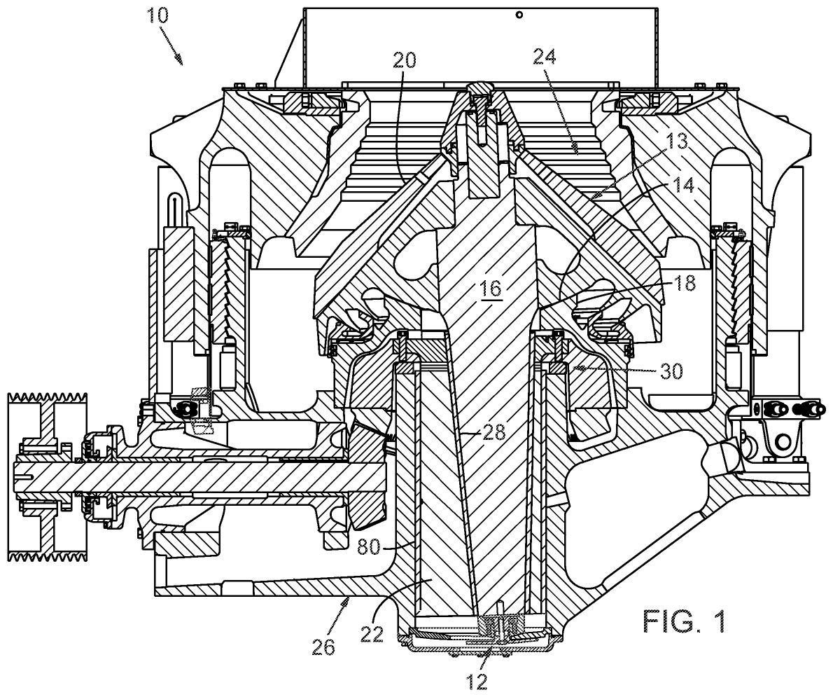

Crusher 10 is largely conventional, except for the pressure plate apparatus, generally indicated at 12, at the bottom of the crusher. FIG. 1 shows that cone crushers include a cone head 13 and a cone head ball surface 14, which is mounted to a central shaft 16. Ball surface 14 is disposed immediately above and rests against a stationary socket 18, which is mounted indirectly to the central shaft. A mantle 20 is mounted to the top of central shaft 16, which gyrates due to the action of a surrounding, rotating eccentric 22. The action of the gyrating mantle 20 against a stationary bowl liner 22 breaks down rocks that enter a crushing zone 24 extending between the mantle and the liner. All of the foregoing components are mounted within a stationary crusher frame 26.

When rocks are fed into a crushing chamber 24, a crushing force acts on mantle 14, pushing the mantle downward and pressing central shaft 16 against a radial bearing 28. But most of the downward force is transmitted from central shaft 16 to ball surface 14 and stationary socket 16 and to a pair of flat, ring-type thrust bearings 30. As described above, this downward thrust of central shaft ball surface against stationary socket 16 creates friction between the ball surface and the socket, tending to prevent central shaft 18 and mantle 20 mounted to it from rotating. However, given the substantial and widely varying thrust forces generating during crushing operations, this force and therefore the amount of friction will vary greatly, providing for the possibility that cone head ball surface 14, central shaft 16 and mantle 20 may from time to time, rotate.

To counter this possibility and to provide a relatively constant amount of pressure between cone head ball surface 14 and stationary socket 18, pressure plate apparatus 12 is provided. This relatively constant pressure is effected by providing a constant downward force on central shaft 16 using a series of springs, the operation of which will be explained as this discussion continues.

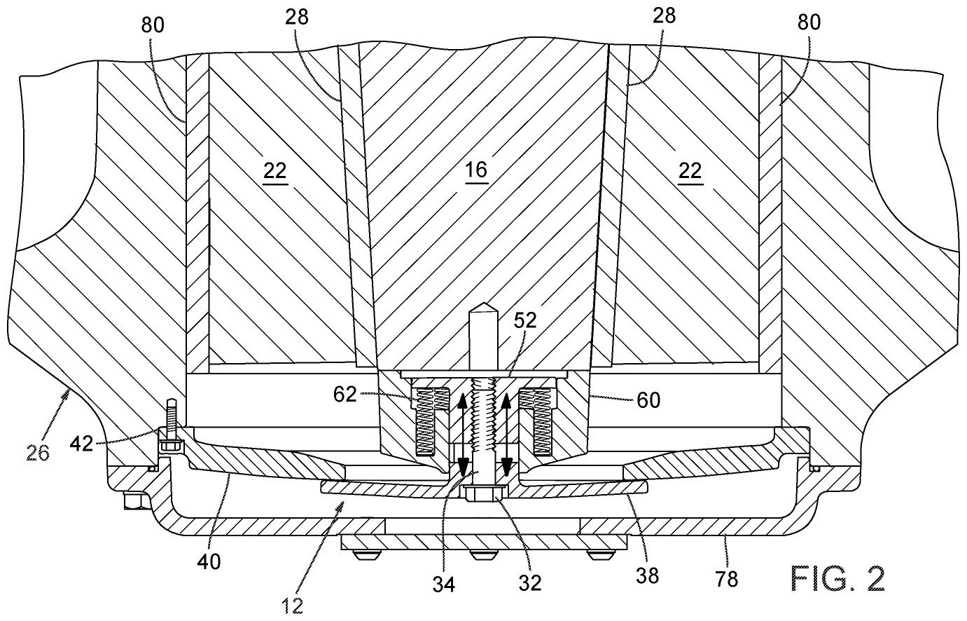

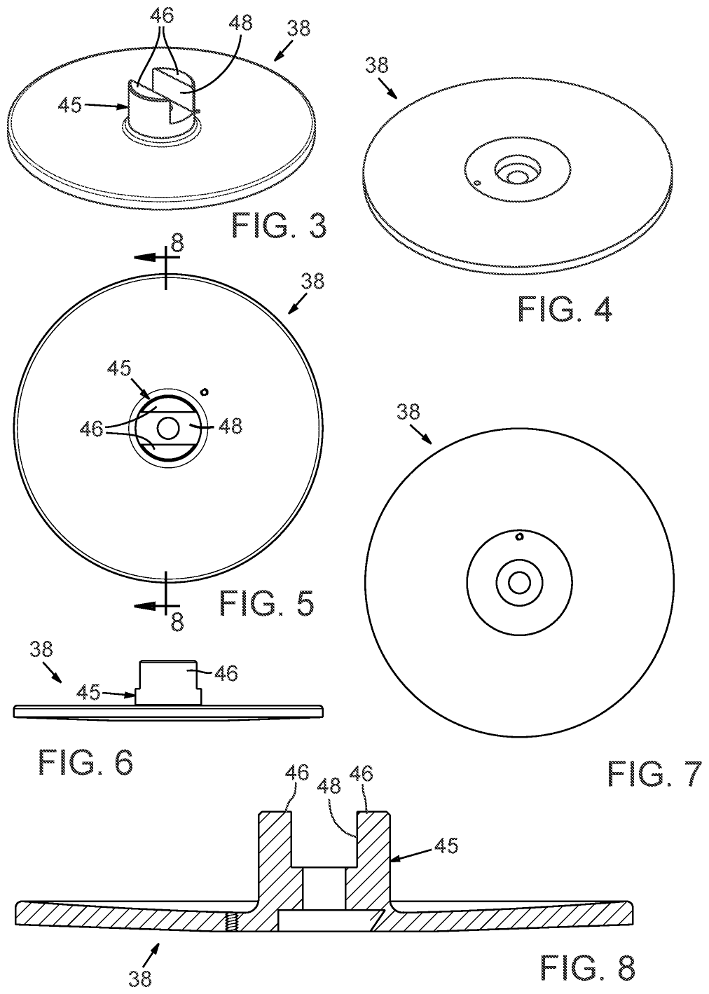

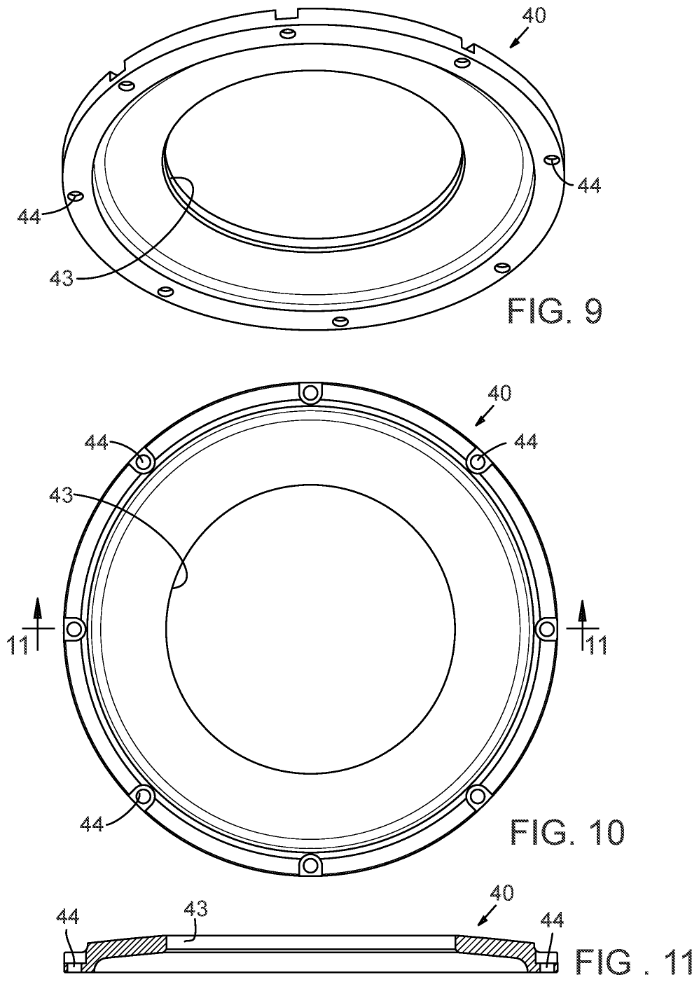

FIG. 1 shows a typical position of a pressure plate 38 in pressure plate apparatus 12. As shown best in FIG. 2, pressure plate 38 is bolted to an end cap 52 by a bolt 34. A bolt head 32 is smaller than the bolt hole so that pressure plate 38 is securely held in place. Pressure plate 38, which is shown in detail in FIGS. 3-8, may be generally circular in configuration. Thrust washer disc 40 is also generally circular in configuration as shown best in FIGS. 9-11, and includes a central aperture 43 that may be said to have a first diameter. Pressure plate 38 may be said to have a second diameter, which is larger than the first diameter of the thrust washer disc central aperture 43. The outer periphery of thrust washer disc 40 includes a flange 42 that is bolted via bolt holes 44 to frame 26.

FIG. 2 shows pressure plate 38 centrally disposed with respect to thrust washer disc 40 although that is because the disc is displaced rearwardly away from the viewer. FIG. 1 shows pressure plate 38 at one side of thrust washer disc 40. Given that eccentric 22 is always off to one side of center, FIG. 1 more clearly illustrates the relative disposition of pressure plate 38 and thrust washer disc 40.

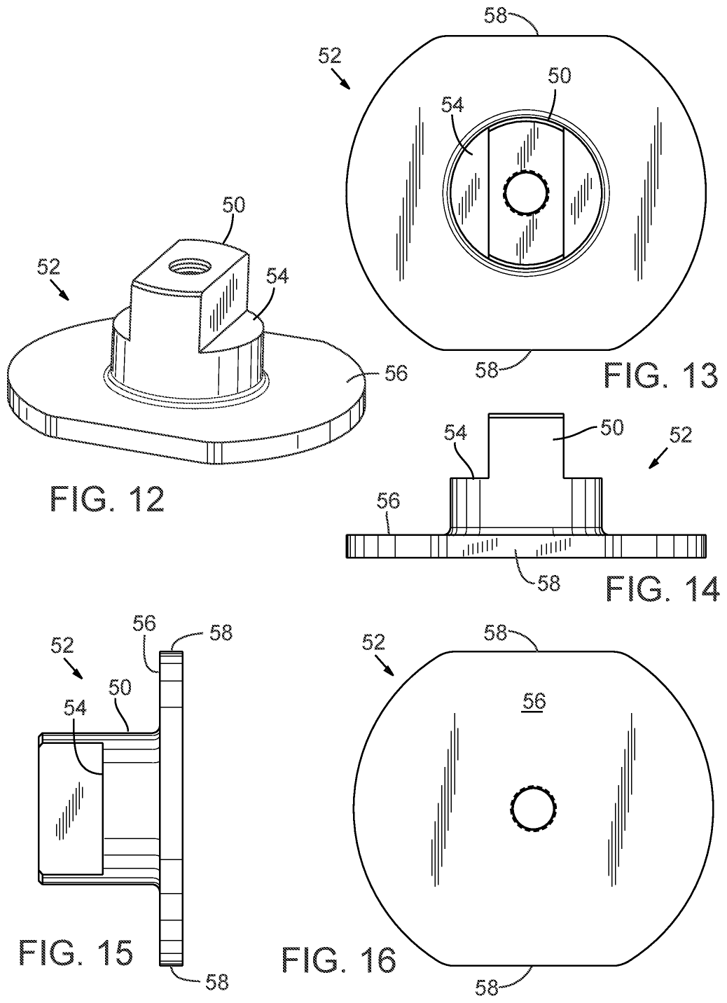

FIGS. 3-8 illustrate that pressure plate 38 includes a bifurcated raised portion 45 comprised of two upwardly extending legs 46, defined by a centrally disposed flat area 48. Fitting slidably between legs 46 is a central extension 50 of an end cap 52, which is shown best in FIGS. 12-16. The end cap also includes a raised annular shoulder 54 and a broad platform 56. Platform 56 is generally circular but includes two opposed flattened edges 58.

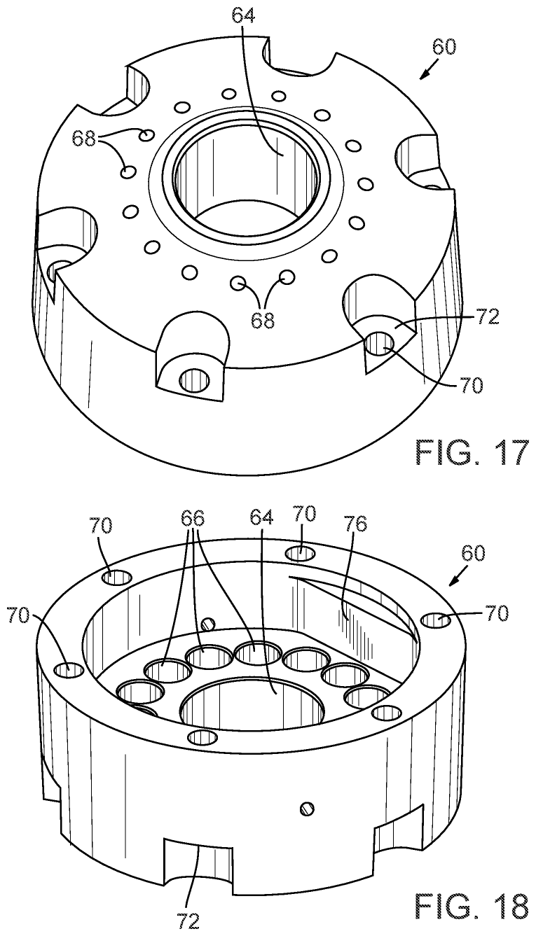

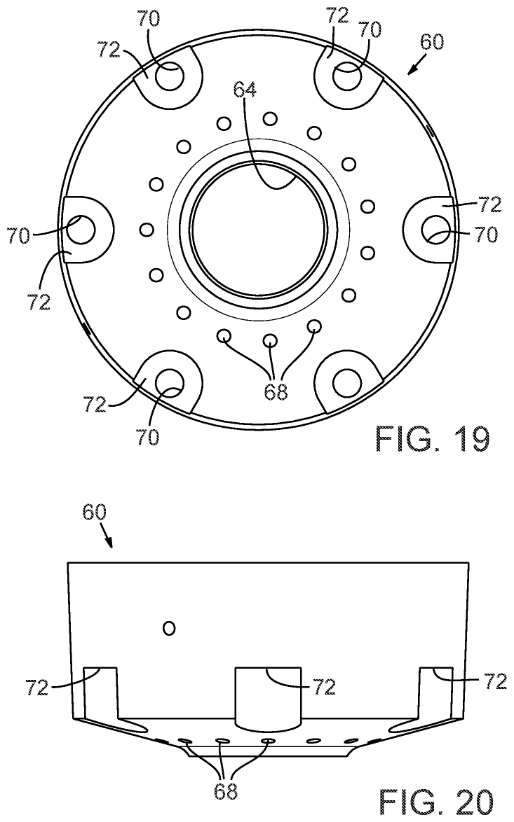

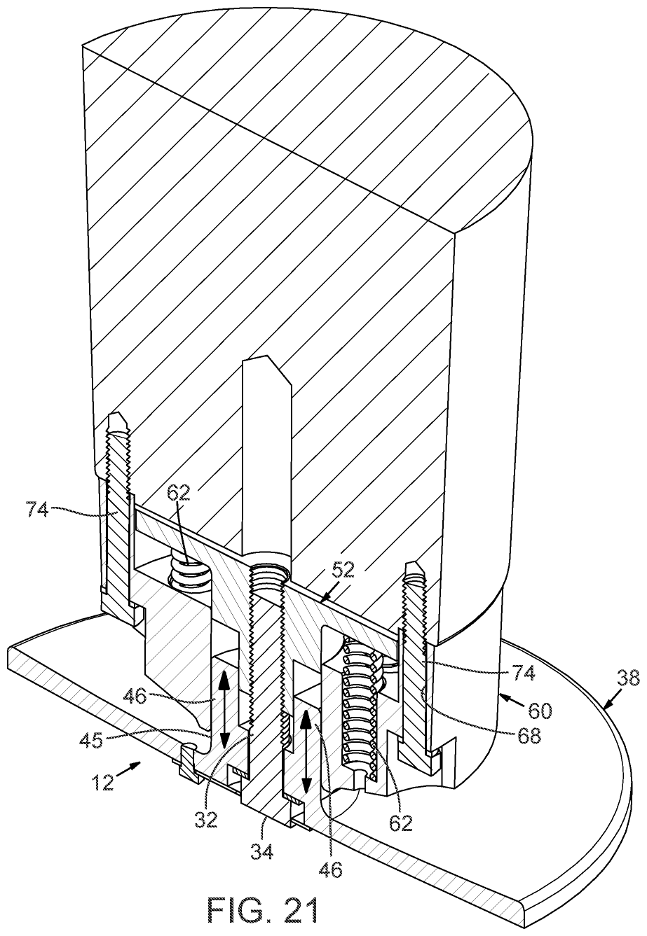

A housing 60 may also be included, which is designed to retain at least one spring. It is possible that a single spring may extend around the housing but the preferred, design includes a plurality of springs 62. The housing is shown best in FIGS. 14-17. It is generally cylindrical but with many features designed to retain various components and fit within and between other components of pressure plate apparatus 12. For example, housing 60 includes a cylindrical passage 64 designed to receive the raised portion 45 of pressure plate 38 as well as the central extension 50 of end cap 52. The housing also includes generally cylindrical holes 66 designed to receive and retain springs 62. In the depicted embodiment, fifteen such holes are included although there may be more or fewer holes. The holes 66 do not extend entirely through housing 60 so that springs 62 bottom out in the housing. Venting apertures 68 may be provided in each of the cylindrical holes 66.

Also included in housing 60 are a plurality of bolt holes 70 evenly positioned around the periphery of the housing, provided with shoulders 72 to support the heads of bolts 74 that extend therethrough. As seen in FIG. 21, bolts 74 serve to mount housing 60 the central shaft 16, which, again, gyrates from side to side with the rotation of eccentric 22 but should not rotate. As shown in FIG. 18, two flat segments 76 extend chord-like across two of the edges of the inner diameter of housing 60 to receive the flattened edges 58 of end cap 52 (see FIGS. 12-16) to ensure that the housing does not rotate with respect to the adjacent components.

As seen best in FIG. 2, a shallow oil pan 78 is provided in the bottom of the crusher below the pressure plate apparatus 12. Oil pan 78 will tend to collect lubricating oil as it drains from radial bearing 28 and an eccentric bearing 80 before draining through a drainage port (not shown) and returning to a lubricating oil reservoir (not shown). Oil flowing into pan 78 ensures that the sliding surfaces between the upper surface of pressure plate 38 and the lower surface of thrust washer disc 40 are fully lubricated and sufficiently cooled while shaft 16 gyrates from side to side and the pressure plate and thrust washer disc surfaces are sliding across each other.

The lubrication between the upper surface of pressure plate 38 and the lower surface of thrust washer disc 40 is further facilitated by the fact that the pressure plate may from time to time during crushing operations be moving slightly up and down with respect to the thrust washer disc, as shown by the arrows in FIG. 2. FIG. 2 depicts pressure plate 38 in its upper-most position against thrust washer disc 40. Upward and downward axial movement of pressure plate 38 is made possible by springs 62, which provide a pulling force on central shaft 16. This in turn ensures that there is pressure between the previously-discussed cone head ball surface 14 and stationary socket 18, minimizing and normally preventing rotation of cone head 13 and central shaft 16. This relatively constant pressure between ball surface 14 and socket 18 also minimizes and normally prevents any cone head lift, resulting from overly-viscous lubricating oil during start up in cold conditions. The cone head ball surface and the stationary socket may sometimes be referred to herein as a first and a second thrust-bearing surface.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1. A system for maintaining a downward force on a central shaft of a cone crusher having a stationary frame, comprising:
a disc fixedly mounted to the frame, the disc having a centrally-disposed aperture with a first diameter;
a plate mounted to an end cap, the plate having a second diameter that is greater than the first diameter, the plate being disposed distally of the disc and the end cap being disposed proximally of the disc; and
a housing fixed to the central shaft and biased away from the end cap wherein a downward bias is imparted to the central shaft.

2. The system of claim 1 wherein the housing is slidably mounted to the end cap.

3. The system of claim 1 wherein the housing is slidably mounted to the plate.

4. The system of claim 1 wherein the housing is slidably mounted to both the end cap and the plate.

5. The system of claim 1 wherein the plate is threadably mounted to the end cap.

6. The system of claim 1 wherein the bias is generated by at least one spring disposed between the housing and the end cap.

7. The system of claim 1 wherein gyration is imparted to the central shaft by an eccentric, and the gyration of the central shaft is passed to the plate, which gyrates with respect to the disc.

8. The system of claim 1 wherein the plate is indirectly mounted to the central shaft such that any gyration of the central shaft is passed on to the plate, which gyrates with respect to the disc and is in contact with an underside of the disc at least part of the time.

9. A pressure plate apparatus for mounting to a central shaft that gyrates in a cone crusher, the pressure plate maintaining a downward force on the central shaft during crushing operations, comprising:
a housing fixed to an underside of the central shaft, the housing slidably receiving an end cap and a raised portion of a plate;
at least one spring mounted between the end cap and the housing to bias the plate toward the central shaft;
a disc fixed to a stationary frame of the crusher, the disc having an aperture with a first diameter and being disposed between the plate and the housing, the plate having a second diameter that is greater than the first diameter; and
wherein the plate gyrates with the central shaft on the disc for some of the crushing operations and, in other crushing operations, the at least one spring pushes the plate away from the disc to maintain a downward force on the central shaft.

10. A process for maintaining downward pressure on the cone of a cone crusher having a stationary frame, a central shaft, a first and a second thrust bearing surface mounted to the central shaft that absorb at least some downward thrust during crushing operations, and a rotating eccentric that gyrates the central shaft with respect to the frame, the process comprising the following steps, not necessarily in the order recited:
positioning at least one spring adjacent a housing;
mounting an end cap to the housing such that the at least one spring is disposed to exert a bias between the housing and the end cap;
fixing the housing to the central shaft and in doing so, compressing the at least one spring;
fixing a disc to a lower portion of the frame, the disc having a centrally-disposed aperture having a first diameter;
selecting a plate having a second diameter that is greater than the first diameter; and
mounting the plate to the end cap such that the disc is disposed between the plate and the end cap so that when crushing operations are initiated, the plate will gyrate with the central shaft and with respect to the disc.

11. The process of claim 10, further comprising maintaining spring tension on the central shaft, thus maintaining pressure between the first and second thrust bearing surfaces.

12. A system for maintaining a downward force on a central shaft of a cone crusher having a stationary frame, comprising:
a disc fixed to the frame, the disc having a substantially centrally-disposed opening; and
a plate mounted to the central shaft, with at least one spring disposed to exert an upward bias on the plate with respect to the central shaft, wherein the plate and the disc are positioned against each other during at least some of the operations of the crusher so that the disc presses downwardly on the plate to exert a downward bias on the central shaft.

13. The system of claim 12, further comprising a housing fixed to the central shaft, with the at least one spring disposed within the housing.

14. The system of claim 13, further comprising an end cap fixed to the plate and slidably mounted to the housing, with the at least one spring disposed to exert a bias between the housing and the end cap.

15. The system of claim 12 wherein gyration is imparted to the central shaft by an eccentric, and the gyration of the central shaft is passed to the plate, which gyrates with respect to the disc.

16. A cone crusher having a gyrating central shaft and a system for maintaining a downward force on the central shaft during crushing operations, the system comprising:
a housing mounted to an underside of the central shaft;
a pressure plate;
an end cap mounted to the pressure plate, the end cap being slidably mounted to the housing;
at least one spring mounted between the end cap and the housing to bias the pressure plate toward the central shaft;
and a disc fixed to the stationary frame, the disc having an opening with which the end cap and the housing are aligned, the pressure plate gyrating with the central shaft while being biased against the disc by the at least one spring, thereby exerting a downward bias to the central shaft during at least some of the crushing operations.

17. A process for maintaining downward pressure on the cone of a cone crusher having a stationary frame, a central shaft and an eccentric that gyrates the central shaft with respect to the frame, the process comprising the following steps, not necessarily in the order recited:
positioning at least one spring adjacent a housing;
mounting the housing to the central shaft;
fixing a disc to the frame, the disc having a substantially centrally-disposed opening; and
mounting a pressure plate to the central shaft, the at least one spring exerting a downward bias on the pressure plate and the central shaft.

18. The process of claim 17, further comprising positioning the pressure plate and the disc such that pressure is exerted between them during at least some crushing operations.

19. A process for maintaining downward pressure on the cone of a cone crusher having a stationary frame, a central shaft and an eccentric that gyrates the central shaft with respect to the frame, the process comprising the following steps, not necessarily in the order recited:
fixing a disc to the frame, the disc having a substantially centrally-disposed opening;
mounting a pressure plate to the central shaft with at least one spring disposed therebetween for exerting a bias forcing the pressure plate toward the central shaft; and
positioning the pressure plate distally of the disc, with the disc in at least intermittent contact with the pressure plate so that the disc forces the pressure plate away from the central shaft, thereby exerting a distal force on the central shaft.
